(19) United States
(12) Patent Application Publication
(10) Pub. No.: US 2026/0328953 A1
(43) Pub. Date: Oct. 22, 2026

(54) RADIATING CABLE POSITIONING METHOD WITHOUT MEASUREMENT BIAS

(71) Applicant: SYNTONY, TOULOUSE (FR)

(72) Inventors: Cyrille GERNOT, SAINTE FOY DE PEYROLIERES (FR); Benjamin PATOUT, TOULOUSE (FR); Jean-Christophe KUCWAJ, TOULOUSE (FR)

(21) Appl. No.: 19/110,557

(22) PCT Filed: Sep. 12, 2023
(86) PCT No.: PCT/FR2023/051390

§ 371 Date: Mar. 11, 2025

(30) Foreign Application Priority Data
Sep. 13, 2022 (FR) 2209208

(51) Int. Cl. G01S 19/45

(52) U.S. Cl. CPC G01S 19/45

(57) ABSTRACT

A method for positioning a mobile terminal along at least one radiating cable located in an indoor environment. A first subset of synthetic GNSS signals is injected at a first end of the cable and a second subset of synthetic GNSS signals is injected at a second end of the cable, the two subsets corresponding to signals which would be received from two separate subsets of satellites which would be visible from a first or a second reference point, in an open-sky configuration. The GNSS receiver of the mobile terminal estimates its position along the cable from the respective deviations between, on one hand, the pseudo-distances measured for the different synthetic GNSS signals received by the terminal and, on the other hand, the reference pseudo-distances calculated for the synthetic GNSS signals received at the reference points. Two parallel radiating cables is also proposed for two-dimensional positioning.

### CROSS REFERENCE TO RELATED APPLICATIONS

This application is a National Stage of International Application No. PCT/FR2023/051390, having an International Filing Date of 12 Sep. 2023, which designated the United States of America, and which International Application was published under PCT Article 21(2) as WO Publication No. 2024/056974, which claims priority from and the benefit of French Patent Application No. 2209208 filed on 13 Sep. 2022, the disclosures of which are incorporated herein by reference in their entireties.

### BACKGROUND

### Field

The present disclosure relates generally to the field of indoor positioning systems, and in particular those for ensuring positioning service continuity with an outdoor environment.

### Brief Description of Related Developments

Satellite positioning systems, also known as Global Navigation Satellite Systems (GNSS), are currently the most commonly used geographic positioning systems. The various GNSS-type satellite constellations (GPS, Galileo, Beidou, GLONASS, IRNSS, etc.) emit GNSS receiver satellite positioning signals to position themselves at any point on the globe.

However, the lack of GNSS signals in indoor environments, and especially in those described as deep indoor environments, such as an underground tunnel, for example, does not allow satellite positioning. This constraint has led to the development of positioning systems specific to indoor environments.

A large number of possible techniques have been used for this purpose. For example, it is known to deploy marker networks in such an environment allowing a dedicated receiver to estimate its position by TDoA (Time Difference of Arrival) or by ToA (Time of Arrival) triangulation. It is also possible to use existing access points, for example of a Wi-Fi network, to determine the position of a terminal using power measurement (RSSI) fingerprints.

However, the aforementioned indoor positioning systems are generally specific to a location and require dedicated receiving equipment. In addition, they do not allow an easy and seamless transition from an outdoor environment to an indoor environment, and vice versa. Indeed, service continuity is generally not guaranteed between these two environments, as outdoor positioning is carried out using GNSS signals while indoor positioning is carried out by means of specific signals.

Patent FR-B-3074921, held by the present Applicant, discloses a system for positioning by means of a radiating cable (“leaky feeder”), at the ends whereof synthetic GNSS signals are injected, these signals being synchronized with actual GNSS signals, as they would be received in the outdoor environment. Thus, a user with a GNSS receiving terminal can determine their position along a radiating cable disposed in an indoor environment and does not have to be affected by a service disruption when entering or exiting this environment.

However, the position measurements obtained by means of the aforementioned positioning system are biased on account of the fact that the synthetic GNSS signals injected into the radiating cable are propagated along the latter and their propagation speed in the cable is lower than in open space. To reduce the measurement bias, the aforementioned patent uses a virtual extension of the cable, on either side of the ends thereof, by a length

$$Δ = \frac{ℓ}{2} ( \frac{c}{v} - 1 )$$

where [symbol] is the length of the radiating cable, c and v being respectively the propagation speed of an electromagnetic wave in vacuum and in the cable. However, this bias is only perfectly compensated when the user is in the middle position, at equal distance from the ends of the cable. This compensation may be insufficient for a long cable once the user moves away from the middle position.

Furthermore, while the positioning method disclosed in the aforementioned patent is well suited to an indoor environment of substantially linear shape (road tunnel or subway track for example), it cannot be used to determine the position of the user two-dimensionally or three-dimensionally in an indoor environment of any shape. Indeed, if a plurality of radiating cables are used in the positioning system of patent FR-B-3074921, only the respective projections of the user's position on the different cables can be determined. On the other hand, the user's position in an orthogonal direction to these cables cannot be determined.

One aim of the present disclosure is hence that of providing a radiating cable positioning method and system that allows a user to be positioned in an indoor environment, without measurement bias, where applicable two-dimensionally or three-dimensionally.

### SUMMARY

The present disclosure is defined by a method for positioning a mobile terminal in an indoor environment wherein at least one first radiating cable having a first end and a second end is located, said positioning method being original in that:
at least a part of a satellite constellation is partitioned into a first and a second separate subsets of satellites, which would be respectively visible from a first reference point and a second reference point, in an open-sky configuration;
for the first (or the second) end, a first (or a second) subset of synthetic GNSS signals corresponding to those which would be received, in an open-sky configuration, is generated by the first (or the second) reference point, from satellites belonging to the first (or the second) subset, the first (or the second) end injecting the first (or the second) subset of synthetic GNSS signals thus generated into the radiating cable;
the GNSS receiver of the mobile terminal measures the pseudo-distances corresponding to the synthetic GNSS signals received from the radiating cable;
for each synthetic GNSS signal of the first (or the second) subset, the deviation between the pseudo-distance measured by the GNSS receiver and a reference pseudo-distance calculated for the first (or the second) reference point is determined;
the position of the mobile terminal along the cable is estimated from the pseudo-distance deviations thus obtained and a georeferenced curve, describing the radiating cable.

The position of the mobile terminal along the radiating cable can then be obtained by solving a system of navigation equations giving the deviations of the pseudo-distances as a function of said position.

The system of equations is advantageously given by:

$${η}_{A} {d}_{A} + y + b = Δ {ρ}_{{A}_{1}}^{j} , j = 1 , … , {N}_{1}$$

$${η}_{A} ( {L}_{A} - {d}_{A} ) + y + b = Δ {ρ}_{{A}_{2}}^{j} , j = 1 , … , {N}_{2}$$

where η_{A} is the ratio between the speed of light and the propagation speed of an electromagnetic wave in the radiating cable, d_{A} is the position of the mobile terminal along the radiating cable taking the first end as the origin, L_{A} is the length of the radiating cable, y is the distance to the radiating cable, b is the clock offset of the GNSS receiver relative to the clock used to generate the synthetic GNSS signals,

$$Δ {ρ}_{{A}_{1}}^{j} ,$$

j=1, . . . , N₁ are the deviations between the pseudo-distances measured by the GNSS receiver and the corresponding reference pseudo-distances, obtained for the N₁ synthetic GNSS signals of the first subset,

$$Δ {ρ}_{{A}_{2}}^{j} ,$$

j=1, . . . , N₂, are the deviations between the pseudo-distances measured by the GNSS receiver and the corresponding reference pseudo-distances, obtained for the N₂ synthetic GNSS signals of the second subset.

The position of the mobile terminal along the radiating cable can be deduced from:

$${d}_{A} = \frac{( Δ {ρ}_{{A}_{1}} - Δ {ρ}_{{A}_{2}} ) / {η}_{A} + {L}_{A}}{2}$$

where

$$Δ {ρ}_{{A}_{1}} = \frac{1}{{N}_{1}} {\sum }_{j = 1}^{{N}_{1}} Δ {ρ}_{{A}_{1}}^{j} , Δ {ρ}_{{A}_{2}} = \frac{1}{{N}_{2}} {\sum }_{j = 1}^{{N}_{2}} Δ {ρ}_{{A}_{2}}^{j}$$

are respectively the mean of the pseudo-distance deviations on the first and second subsets.

According to a second aspect of the method for positioning a mobile terminal, the indoor environment comprises at least a first radiating cable and a second radiating cable, each radiating cable having a first end and a second end, the positioning method being original in that:
at least a part of a satellite constellation is partitioned into a first, second, third and fourth separate subsets of satellites, which would be respectively visible from a first, second, third and fourth point of reference in an open-sky configuration;
for the first (or the second) end of the first cable, a first (or a second) subset of synthetic GNSS signals corresponding to those which would be received, in an open-sky configuration, is generated by the first (or the second) reference point, from satellites belonging to the first, (or the second) subset, the first, (or the second) end of the first cable injecting the first (or the second) subset of synthetic GNSS signals thus generated into the first radiating cable;
for the first (or the second) end of the second cable, a third (or a fourth) subset of synthetic GNSS signals corresponding to those which would be received, in an open-sky configuration, is generated by the third (or the fourth) reference point, from satellites belonging to the third (or the fourth) subset, the first (or the second) end of the second cable injecting the third (or the fourth) subset of synthetic GNSS signals thus generated into the second radiating cable;
the GNSS receiver of the mobile terminal measures the pseudo-distances corresponding to the synthetic GNSS signals received from the first and second radiating cables;
for each synthetic GNSS signal of the first (or the second, third, fourth) subset, the deviation between the pseudo-distance measured by the GNSS receiver and a reference pseudo-distance calculated for the first (or the second, third, fourth) reference point is determined;
the position of the mobile terminal along the first and/or second cable and the distance to the first and/or second cable are estimated from the pseudo-distance deviations thus obtained and georeferenced curves, respectively describing the first and second radiating cables.

The position of the mobile terminal along the and/or second radiating cable and the distance to the first and/or second cable can then be obtained by solving a system of navigation equations giving the deviations of the pseudo-distances as a function of the position of the mobile terminal, respectively along the first radiating cable and the second radiating cable as well as its distance respectively to the first radiating cable and to the second radiating cable.

Advantageously, the first and second radiating cables are parallel and separated by a distance H and the system of equations is given by:

$${η}_{A} {d}_{A} + y + b = Δ {ρ}_{{A}_{1}}^{j} , j = 1 , … , {N}_{1} ;$$

$${η}_{A} ( {L}_{A} - {d}_{A} ) + y + b = Δ {ρ}_{{A}_{1}}^{j} , j = 1 , … , {N}_{2} ;$$

$${η}_{B} {d}_{B} + ( H - y ) + b = Δ {ρ}_{{B}_{1}}^{j} , j = 1 , … , {M}_{1} ;$$

$${η}_{B} ( {L}_{B} - {d}_{B} ) + ( H - y ) + b = Δ {ρ}_{{B}_{2}}^{j} , j = 1 , … , {M}_{2} ;$$

where η_{A}, η_{B} is the ratio between the speed of light and the propagation speed of an electromagnetic wave respectively in the first and second radiating cable; d_{A}, d_{B} is the position of the mobile terminal respectively along the first and second radiating cable taking the first end of these cables as the origin; L_{A}, L_{B} is the respective length of the first and second radiating cable, y is the distance from the user to the first radiating cable, b is the clock offset of the GNSS receiver relative to the clock used to generate the synthetic GNSS signals;

$${Δρ}_{{A}_{1}}^{j} , j = 1 , … , {N}_{1} and {Δρ}_{{A}_{2}}^{j} , j = 1 , … , {N}_{2}$$

are the deviations between the pseudo-distances measured by the GNSS receiver and the corresponding reference pseudo-distances, respectively obtained for the N₁ synthetic GNSS signals of the first subset and the N₂ synthetic GNSS signals of the second subset;

$${Δρ}_{{B}_{1}}^{j} , j = 1 , … , {M}_{1} and {Δρ}_{{B}_{2}}^{j} , j = 1 , … , {M}_{2}$$

are the deviations between the pseudo-distances measured by the GNSS receiver and the corresponding reference pseudo-distances, respectively obtained for the M₁ synthetic GNSS signals of the third subset, and the M₂ synthetic GNSS signals of the fourth subset.

The position of the mobile terminal along the first, or second radiating cable can be deduced from:

$${d}_{A} = \frac{( Δ {ρ}_{{A}_{1}} - Δ {ρ}_{{A}_{2}} ) / {η}_{A} + {L}_{A}}{2}$$

$${d}_{B} = \frac{( Δ {ρ}_{{B}_{1}} - Δ {ρ}_{{B}_{2}} ) / {η}_{B} + {L}_{B}}{2}$$

where

$$Δ {ρ}_{{A}_{1}} = \frac{1}{{N}_{1}} {\sum }_{j = 1}^{{N}_{1}} Δ {ρ}_{{A}_{1}}^{j} , Δ {ρ}_{{A}_{2}} = \frac{1}{{N}_{2}} {\sum }_{j = 1}^{{N}_{2}} Δ {ρ}_{{A}_{2}}^{j}$$

are respectively the mean of the pseudo-distance deviations on the first and second subsets, and

$$Δ {ρ}_{{B}_{1}} = \frac{1}{{M}_{1}} {\sum }_{j = 1}^{{M}_{1}} Δ {ρ}_{{B}_{1}}^{j} , Δ {ρ}_{{B}_{2}} = \frac{1}{{M}_{2}} {\sum }_{j = 1}^{{M}_{2}} Δ {ρ}_{{B}_{2}}^{j}$$

are respectively the mean of the pseudo-distance deviations on the third and fourth subsets.

The distance from the mobile terminal to the first radiating cable is given by:

$$y = \frac{( Δ {ρ}_{{A}_{1}} - Δ {ρ}_{{B}_{1}} ) + ( Δ {ρ}_{{A}_{2}} - Δ {ρ}_{{B}_{2}} ) - ( {η}_{A} {L}_{A} - {η}_{B} {L}_{B} ) + 2 H}{4}$$

Regardless of the aspect, the synthetic GNSS signals can be generated by means of a simulator receiving at least one actual satellite signal from a satellite of said constellation, via an antenna located in an outdoor environment, the synthetic GNSS signals being synchronized with respect to the actual satellite signal.

### BRIEF DESCRIPTION OF THE DRAWINGS

Other features and advantages of the disclosure will become apparent upon reading a preferred aspect of the disclosure, with reference to the appended figures wherein:

FIG. 1 schematically represents a positioning system according to a first aspect of the disclosure;

FIG. 2A and

FIG. 2B schematically illustrate an example of an open-sky partition that can be used in implementing a positioning method according to the aspect of FIG. 1;

FIG. 3 schematically represents a positioning system according to a second aspect of the disclosure;

FIG. 4A and

FIG. 4B schematically illustrate an example of an open-sky partition that can be used in implementing a positioning method according to the aspect of FIG. 3;

FIG. 5 schematically represents a positioning method according to the first aspect of the present disclosure;

FIG. 6 schematically represents a positioning method according to the second aspect of the present disclosure.

### DETAILED DESCRIPTION

Hereinafter, we consider an environment wherein GNSS signal reception is virtually impossible, in particular an indoor environment, or even totally impossible (so-called “deep indoor” environment). The term GNSS (Global Navigation Satellite System) signals means here any type of satellite signal allowing positioning regardless of the satellite system in question (GPS, Galileo, GLONASS, Beidou, etc.). Finally, the term GNSS receiver means GNSS signal receiving devices complying with the standards defined in the ICDs (Interface Control Documents) of the satellite systems in question, making it possible to extract GNSS observable measurements such as pseudo-distance measurements therefrom.

Hereinafter, for illustration purposes only and without loss of generality, we will assume that the satellite system is a GPS system. The indoor environment is separated by a boundary from an outdoor environment where GNSS signals are received in an open-sky configuration. Typical but non-limiting use cases of the present disclosure are, for example, underground infrastructures or buildings.

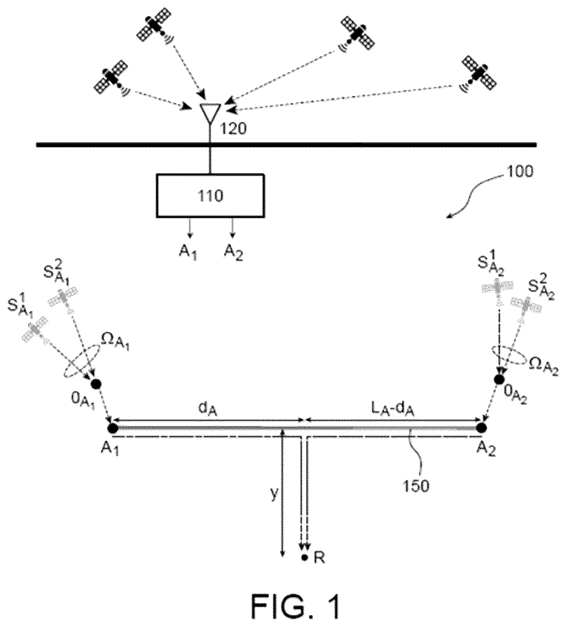

FIG. 1 schematically represents a positioning system according to a first aspect of the disclosure.

This system, 100, comprises means for generating synthetic signals (also referred to hereinafter as “synthetic signal simulator”), 110, receiving at least one actual GNNS signal (and generally a plurality of such actual GNSS signals) from an antenna, 120, located in an outdoor environment. These generation means, described in detail hereinafter, provide synthetic GNSS signals, synchronized with said at least actual GNSS signal, at the ends A₁ and A₂ of a radiating cable, 150, located in the indoor environment. The term synthetic GNSS signals means a set of simulated GNSS signals corresponding to a reception at a given reference position, i.e. GNSS signals as they would be received in an outdoor environment for a position configured by the generation means 110. In this document, O_{A}_{₁} and O_{A}_{₂}, will annotate the reference positions configured for the simulation of GNSS satellite signals injected at each end of the cable A₁ and A₂.

It should be noted that the reference positions configured for the simulation of synthetic GNSS signals by the generation means 110 are not necessarily those of the ends of the cable. They can generally be reference positions located on the cable or not.

In a particular scenario, the reference positions configured by 110 may be chosen as identical to the positions of the physical ends of the radiating cables used as emission means (i.e. the positions of the ends A₁ and A₂).

The term radiating cable (“leaky feeder”) typically means a coaxial cable wherein the outer conductor has slots at regular intervals so as to allow radial emission along its entire length. Equivalently, any waveguide, with slots or with openings, having a large extension along its longitudinal axis and allowing radial emission along this axis, may be used. It should be noted that the radiating cable is not necessarily rectilinear, it can be at least curvilinear along at least part of its length. However, by way of introduction and for the purpose of simplifying the disclosure of the disclosure, we will assume that the cable is rectilinear.

The set Ω of synthetic signals generated by the generation means 110, is partitioned into two separate subsets Ω_{A}_{₁}, Ω_{A}_{₂} The subset Ω_{A}_{₁} (or Ω_{A}_{₂}) associated with the end A₁ (or A₂) is made up of GNSS signals which would be received at the same time at a first (or a second) reference point O_{A}_{₁} (or O_{A}_{₂}) in an open-sky configuration, i.e. without any propagation obstacle between this first (or second) reference point and the sky. For example, in the aforementioned particular aspect, the subset Ω_{A}_{₁} (or Ω_{A}_{₂}) of satellite signals generated by 110 and injected into the radiating cable radiating via the end A₁ (or A₂), can be defined by a subset of simulated GNSS signals corresponding to satellite GNSS signals received at a reference point O_{A}_{₁} (or O_{A}_{₂}). These satellite signals are associated with the theoretically visible satellites of the point O_{A}_{₁} (or O_{A}_{₂}) in a visibility cone above the horizon, with the vertex O_{A}_{₁} (or O_{A}_{₂}). The vertex visibility cones O_{A}_{₁} and O_{A}_{₂} (corresponding to the signals injected at A₁ and A₂) are chosen as separate. In a particular aspect, identical first and second reference points may be taken, the subsets Ω_{A}_{₁} and Ω_{A}_{₂} always being chosen as separate.

Advantageously, it may be provided that the directions of the visibility cones have an angular deviation in azimuth and/or elevation between them greater than a threshold value.

Hereinafter,

$${s}_{{A}_{i}}^{j} ,$$

where j=1, . . . , Nᵢ and i=1.2, will annotate the synthetic GNSS signals simulated for a reference position O_{A}_{ᵢ} and injected at each end of the radiating cable A, in other words belonging to the subset Ω_{A}_{ᵢ} where

$${S}_{{A}_{i}}^{j}$$

j=1, . . . , Nᵢ the corresponding simulated satellites. It will be assumed that N₁, N₂≥1, in other words that each of the two subsets is not nil and that N₁+N₂≥4 to allow the GNSS receiver to perform pseudo-distance measurements conventionally.

Thus, in FIG. 1, the end A₁ receives at the time t, from the generation means 100, the synthetic GNSS signals

$${s}_{{A}_{1}}^{1} ( t ) , {s}_{{A}_{1}}^{2} ( t )$$

which would be received at the same time by the first simulated reference point O_{A}_{₁}, in an open-sky configuration. Similarly, the end A₂ receives at the time t, from the generation means 100, the synthetic GNSS signals

$${s}_{{A}_{2}}^{1} ( t ) , {s}_{{A}_{2}}^{2} ( t )$$

which would be received at the same time by the second simulated reference point O_{A}_{₂}, in an open-sky configuration. Hereinafter, the time t will be omitted, it being understood that the means for generating synthetic GNSS signals are synchronized with the time of an actual GNSS signal. More specifically, the local clock of the simulator 110 is set to said at least one actual GNSS signal received from the antenna 120, the offset between the local clock of the simulator and the GPS time being constant.

It should also be noted, in particular for a spatially extended positioning system, that the signals provided by the generation means can be offset in time, in order to compensate for the respective propagation times in the feed cables (not shown) connecting the simulator and the ends A₁ and A₂.

The synthetic GNSS signals

$${s}_{{A}_{1}}^{j} ,$$

j=1, . . . , N₁ of the subset Ω_{A}_{₁} are injected at A₁ into the radiating cable 150 and are propagated therein toward A₂ while being radiated radially along the cable. Similarly, the synthetic GNSS signals

$${s}_{{A}_{2}}^{j} ,$$

j=1, . . . , N₂ of the subset Ω_{A}_{₂} are injected into the radiating cable 150, and are propagated therein toward A₁ while being radiated radially along the cable.

By definition of the synthetic GNSS signals

$${s}_{{A}_{i}}^{j} ,$$

j=1, . . . , Nᵢ of the subset Ω_{A}_{ᵢ}, a GNSS receiver synchronized on the same internal clock as the simulator and receiving these signals directly at the output of the simulator 110, as injected at Aᵢ, would measure pseudo-distances

$${ρ}_{{A}_{i}}^{j}$$

relative to the distances between the simulated reference position O_{A}_{ᵢ} and the simulated satellites

$${S}_{{A}_{i}}^{j} ,$$

j=1, . . . , Nᵢ.

These pseudo-distances

$${ρ}_{{A}_{i}}^{j} ,$$

can be calculated at any time by the simulator, based on almanac, ephemeris information and a GPS time. The almanac and ephemeris information of each satellite can be obtained directly by demodulating the navigation messages of the actual GNSS signals received by the simulator or by a remote server. The GPS time can be given by one of the actual GNSS signals received. Thus, it is not necessary for all the actual GNSS signals to be actually received by the antenna 120. The navigation messages for missing actual signals (e.g. from satellites obscured by obstacles in urban areas) can be provided by a remote server.

The pseudo-distances

$${ρ}_{{A}_{i}}^{j} ,$$

j=1, . . . , N_{A}_{ᵢ}, i=1.2 are hereinafter referred to as reference pseudo-distances because they are calculated without using measurements, for each of the reference points O_{A}_{ᵢ}, i=1.2. It should be noted that for a given simulated satellite constellation, the reference pseudo-distances are only dependent on the reference positions O_{A}_{ᵢ}, i=1.2, the position of the satellites

$${S}_{{A}_{i}}^{j}$$

and the GPS time.

A GNSS signal receiver located at the point R, for example part of a user's mobile terminal, measures the following pseudo-distances

$${\tilde{ρ}}_{{A}_{i}}^{j} ,$$

relative to the synthetic GNSS signals received,

$${s}_{{A}_{i}}^{j} ,$$

with the following relation:

$$\begin{matrix}[ Math . 1 ] & \\ {\tilde{ρ}}_{{A}_{i}}^{j} = {ρ}_{{A}_{i}}^{j} + {η}_{A} {d}_{{A}_{i}} + y + b + {w}_{{A}_{i}}^{j} & ( 1 )\end{matrix}$$

where d_{A}_{ᵢ} is the distance separating the end Aᵢ of the cable and the orthogonal projection of R on the radiating cable;

$${η}_{A} = \frac{c}{{v}_{A}}$$

is the velocity factor in the cable (ratio of the speed of light to the propagation speed v_{A} of a wave in the radiating cable); b corresponds to the offset between the clock of the GNSS receiver and that of the simulator 110; y is the distance between the position R of the GNNS receiver and the cable;

$${w}_{{A}_{i}}^{j}$$

is a pseudo-distance measurement noise. Given that the synthetic GNSS signals of the same subset Ω_{A}_{ᵢ} follow the same propagation path, it can be legitimately considered that the measurement noises

$${w}_{{A}_{i}}^{j}$$

are not dependent on the index of the simulated satellite j. If the measurement noise in question is disregarded, the deviation between a pseudo-distance

$${\tilde{ρ}}_{{A}_{i}}^{j}$$

measured by the GNSS receiver and the corresponding reference pseudo-distance

$${ρ}_{{A}_{i}}^{j}$$

is only a function of the propagation distance in the cable, the distance from the GNSS receiver to the cable and the clock offset of the receiver to the simulator. This deviation between the reference (or theoretical) pseudo-distance associated with Aᵢ and the same pseudo-distance measured after propagation of the signal in the cable, annotated as

$${Δρ}_{{A}_{i}}^{j} ,$$

is expressed as follows:

$$\begin{matrix}[ Math . 2 ] & \\ {Δρ}_{{A}_{i}}^{j} = {\tilde{ρ}}_{{A}_{i}}^{j} - {ρ}_{{A}_{i}}^{j} = {η}_{A} {d}_{{A}_{i}} + y + b & ( 2 )\end{matrix}$$

Hereinafter, the first end of the cable A₁ will be arbitrarily taken as a reference. The distance d_{A} along the cable is merely d_{A}=d_{A}, and we have d_{A}_{₂}=L_{A}−d_{A} where L_{A} is the length of the cable.

The measured pseudo-distances

$${\tilde{ρ}}_{{A}_{i}}^{j} ,$$

j=1, . . . , N_{A}_{ᵢ}, i=1.2 are provided directly by the GNSS receiver of the mobile terminal.

The reference pseudo-distances

$${ρ}_{{A}_{i}}^{j} ,$$

1, . . . , N_{A}_{ᵢ}, i=1.2 are also known to the mobile terminal. Indeed, the latter are only dependent on the simulated reference position O_{A}_{ᵢ}, and the associated visible satellites

$${S}_{{A}_{i}}^{j} .$$

For this purpose, there are different possible variants:

According to a first variant, the reference pseudo-distances are calculated at each time by the simulator, from navigation messages received from the various satellites and/or almanac/ephemeris data provided by a remote server, and the positions of the reference points. In this case, the reference pseudo-distances can be transmitted via an auxiliary channel to the mobile terminal.

According to a second variant, the reference pseudo-distances are calculated at each time by a remote server, from the almanac/ephemeris data of the various satellites, as well as the positions of the reference points. The reference pseudo-distances thus calculated can be transmitted to the mobile device via Wi-Fi access points located within the indoor environment or via a communication system deployed within this environment. According to a third variant, the theoretical pseudo-distances are calculated at each time by the mobile terminal itself based on the almanac/ephemeris data of the various satellites, and the positions of the reference points. For this purpose, almanac/ephemeris data and reference positions can be transmitted from a remote server, via Wi-Fi access points or via any other communication system deployed in the indoor environment.

Regardless of the alternative aspect, the local coordinates (x_{A}_{ᵢ}, y_{A}_{ᵢ}, z_{A}_{ᵢ}) of the ends Aᵢ, i=1.2 of the cable are known in a mapping reference system (geographic reference system, building or infrastructure plan) are known to the mobile terminal, and can be provided to a navigation application.

The mobile terminal solves a system of N₁+N₂ navigation equations with three unknowns, namely the coordinate d_{A}, the distance to the cable y, and the clock offset b, where the observables are the pseudo-distances

$${\tilde{ρ}}_{{A}_{i}}^{j} ,$$

relative to the synthetic GNSS signals,

$${s}_{{A}_{i}}^{j} ,$$

received via the radiating cable and

$${ρ}_{{A}_{i}}^{j}$$

the associated theoretical pseudo-distances:

$$\begin{matrix}[ Math . 3 ] & \\ {Δρ}_{{A}_{1}}^{j} = {\tilde{ρ}}_{{A}_{1}}^{j} - {ρ}_{{A}_{1}}^{j} = {η}_{A} {d}_{A} + y + b , j = 1 , … , {N}_{1} & ( 3 - 1 )\end{matrix}$$

$$\begin{matrix}[ Math . 4 ] & \\ {Δρ}_{{A}_{2}}^{j} = {\tilde{ρ}}_{{A}_{2}}^{j} - {ρ}_{{A}_{2}}^{j} = {η}_{A} ( {L}_{A} - {d}_{A} ) + y + b , j = 1 , … , {N}_{2} & ( 3 - 2 )\end{matrix}$$

Knowing the local coordinates of each cable end and eliminating the sum y+b between the equations makes it possible to determine the coordinate d_{A}, in other words the coordinate of the position of the mobile terminal along the cable axis taking the end A₁ as the origin. However, this first aspect alone does not allow the ordinate y and the clock offset b to be determined separately.

The system of navigation equations (3-1), (3-2) can be solved conventionally, for example with a least squares method, if the system is overdetermined, in a manner known per se.

According to an exemplary aspect, the pseudo-distance deviations for each of the subsets Ω_{A}_{ᵢ} may simply be averaged:

$$\begin{matrix}[ Math . 5 ] & \\ Δ {ρ}_{{A}_{1}} = \frac{1}{{N}_{1}} {\sum }_{j = 1}^{{N}_{1}} Δ {ρ}_{{A}_{1}}^{j} & ( 4 - 1 )\end{matrix}$$

$$\begin{matrix}[ Math . 6 ] & \\ Δ {ρ}_{{A}_{2}} = \frac{1}{{N}_{2}} {\sum }_{j = 1}^{{N}_{2}} Δ {ρ}_{{A}_{2}}^{j} & ( 4 - 2 )\end{matrix}$$

and the coordinate d_{A} of the position of the mobile terminal deduced therefrom with the following relation:

$$\begin{matrix}[ Math \text{.7} ] & \\ {d}_{A} = \frac{( Δ {ρ}_{{A}_{1}} - Δ {ρ}_{{A}_{2}} ) / {η}_{A} + {L}_{A}}{2} & ( 5 )\end{matrix}$$

Knowing the coordinates (x_{A}_{ᵢ}, y_{A}_{ᵢ}, z_{A}_{ᵢ}) of the ends Aᵢ, i=1.2 of the cable in a local coordinate system, it is possible to deduce the position of the orthogonal projection of the point R where the user is located in the same coordinate system and provide it to a specific navigation application (tunnel, underground road network, for example).

Until now, it has been assumed that the radiating cable is rectilinear. However, a person skilled in the art will understand that the positioning method according to the first aspect also applies to a curvilinear cable wherein the mobile terminal knows the curve spatially. Indeed, the coordinate d_{A} is merely the curvilinear abscissa along the cable taking the first end A₁ as the origin, this coordinate giving the position of the orthogonal projection of the point R on the cable.

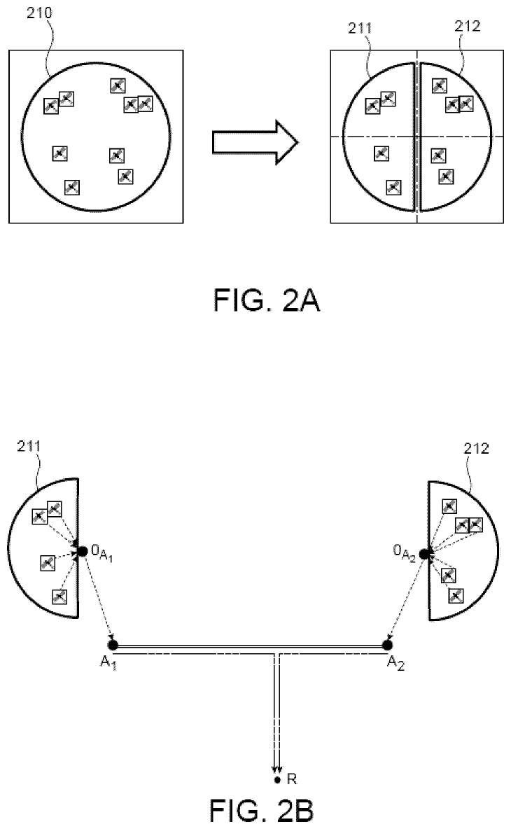

FIGS. 2A and 2B schematically illustrate an example of an open-sky partition that can be used in implementing a positioning method according to the first aspect of the disclosure.

A top view of an open-sky configuration showing a satellite constellation at a given time has been represented in 210. This configuration is here partitioned into two parts, 211, 212, corresponding here to two opposite directions.

FIG. 2B illustrates the radiating cable in the indoor environment and the allocation of satellites/GNSS signals to each of its ends. It is verified that the subsets Ω_{A}_{ᵢ}, i=1.2 are separate and that each of them comprises at least one element.

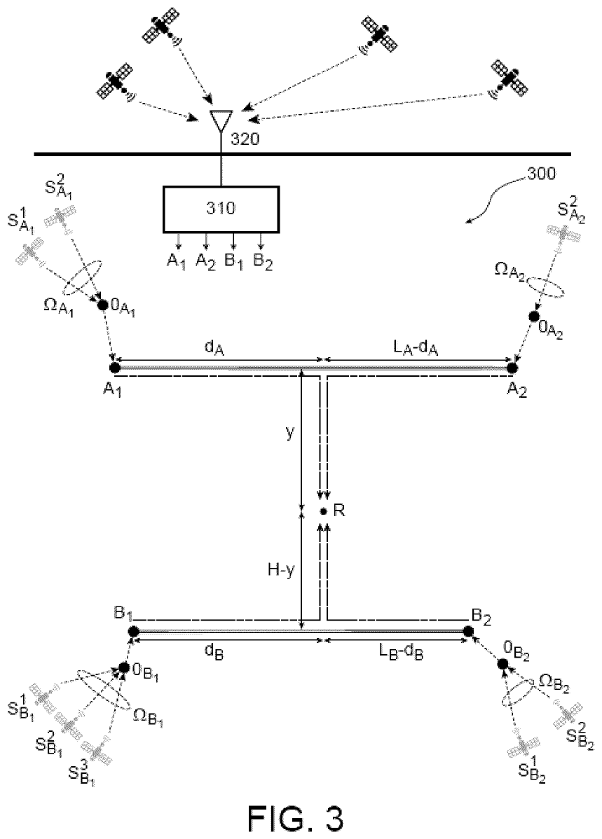

FIG. 3 schematically represents a system for positioning a mobile terminal according to a second aspect of the present disclosure

Unlike the first positioning system illustrated in FIG. 1, the positioning system according to the second aspect of the disclosure comprises two parallel coplanar radiating cables, 350 and 370, located in an indoor environment, namely a first cable A, 350, of length L_{A} and a second cable B, 370, of length L_{B}. We will firstly assume that these two cables are rectilinear and separated by a distance H.

Generation means 310 receive at least one actual GNNS signal from an antenna, 320, located in the outdoor environment and provide synthetic GNSS signals, synchronized with said at least actual GNSS signal, at the ends A₁ and A₂ of the first radiating cable, 350, on one hand, and at the ends B₁ and B₂ of the second radiating cable, 370, on the other.

The set Ω of synthetic signals generated by the generation means 310, is partitioned into four separate subsets pairwise, namely Ω_{A}_{₁}, Ω_{A}_{₂}, respectively associated with a first and a second simulated reference point, annotated as O_{A}_{₁} and O_{A}_{₂}, the signals of Ω_{A}_{₁}, Ω_{A}_{₂} being respectively injected into the radiating cable at A₁ and A₂; and Ω_{B}_{₁}, Ω_{B}_{₂}, respectively associated with a third and a fourth simulated reference point, annotated as O_{B}_{₁} and O_{B}_{₂}, the signals of Ω_{B}_{₁}, Ω_{B}_{₂} being respectively injected into the radiating cable at B₁ and B₂.

At a given time, the subset of GNSS signals associated with a reference point is made up of signals which would be received at the same time at that point in an open-sky configuration, i.e. without any propagation obstacles between that point and the sky.

As in the first aspect, the subsets Ω_{A}_{₁}, or Ω_{A}_{₂}, and Ω_{B}_{₁}, or Ω_{B}_{₂}, can be defined by subsets of GNSS signals received from satellites visible from the simulated positions O_{A}_{₁}, or Ω_{A}_{₂} at A₁, or A₂, and O_{B}_{₁}, or O_{B}_{₂} at B₁, or B₂, in visibility cones defined in elevation above the horizon, and in azimuth. The four visibility cones being chosen as separate pairwise.

In the aforementioned particular aspect, the subset Ω_{B}_{₁} (or Ω_{B}_{₂}) can be defined by a subset of GNSS signals received from satellites visible from the simulated reference point O_{B}_{₁} (or O_{B}_{₂}) in a visibility cone above the horizon, defined in elevation and azimuth. The vertex visibility cones O_{A}_{₁}, O_{A}_{₂}, O_{B}_{₁}, O_{B}_{₂} corresponding to the simulations of GNSS signals injected at A₁, A₂, B₁, B₂ are chosen as separate.

Advantageously, it may be provided that the directions of the visibility cones have an angular deviation in azimuth and/or elevation between them greater than a threshold value.

$${s}_{{B}_{i}}^{j} ,$$

j=1, . . . , Mᵢ, i=1.2 will annotate the synthetic GNSS signals injected at each end of the radiating cable B, i.e. belonging to the subset Ω_{B}_{ᵢ} and

$${S}_{{B}_{i}}^{j} ,$$

j=1, . . . , Mᵢ the corresponding simulated satellites. It will be assumed that M₁, M₂≥1 and that N₁+N₂+M₁+M₂≥4 to allow the GNSS receiver to make pseudo-distance measurements conventionally.

As in the first aspect, the synthetic GNSS signal generation means 310 are synchronized with the time of an actual GNSS signal. Furthermore, the signals provided by the generation means can be offset in time, in order to compensate for the respective propagation times in the feed cables (not shown) connecting the simulator and the ends A₁, A₂, B₁, B₂.

The synthetic GNSS signals

$${s}_{{B}_{1}}^{j} ,$$

j=1, . . . , M₁ of the subset Ω_{B}_{₁} are injected into the radiating cable 370 at B₁ and are propagated therein toward B₂ while being radiated radially along the cable. Similarly, the synthetic GNSS signals

$${s}_{{B}_{2}}^{j} ,$$

j=1, . . . , M₂ of the subset Ω_{B}_{₂} are injected into the radiating cable 370 at B₂ and are propagated therein toward B₁ while being radiated radially along the same cable.

By definition of the synthetic GNSS signals

$${s}_{{B}_{i}}^{j} ,$$

j=1, . . . , Mᵢ, i=1.2 of the subset Ω_{B}_{ᵢ}, a GNNS receiver receiving simulated GNSS signals, directly at the output of the simulator 110, as injected at Bᵢ, and provided with the same internal clock as the simulator, would measure pseudo-distances

$${ρ}_{{B}_{i}}^{j}$$

relative to the distances between the position located at the reference point O_{B}_{ᵢ} and the position of the satellites

$${S}_{{B}_{i}}^{j} ,$$

j=1, . . . , Mᵢ visible in the associated visibility cone.

Thus, a GNSS signal receiver located at the point R, for example part of a user's mobile terminal, measures the pseudo-distances, relative to the simulated reference positions O_{A}_{ᵢ}, i=1.2 and O_{B}_{ᵢ}, i=1.2, and to the simulated satellites

$${S}_{{A}_{i}}^{j} ,$$

j=1, . . . , Nᵢ and

$${S}_{{B}_{i}}^{j} ,$$

j=1, . . . , Mᵢ:

$$\begin{matrix}[ Math \text{.8} ] & \\ {\tilde{ρ}}_{{A}_{i}}^{j} = {ρ}_{{A}_{i}}^{j} + {η}_{A} {d}_{{A}_{i}} + y + b + {w}_{{A}_{i}}^{j} , j = 1 , … , {N}_{i} & ( 6 - 1 )\end{matrix}$$

$$\begin{matrix}[ Math \text{.9} ] & \\ {\tilde{ρ}}_{{B}_{i}}^{j} = {ρ}_{{B}_{i}}^{j} + {η}_{B} {d}_{{B}_{i}} + ( H - y ) + b + {w}_{{B}_{i}}^{j} , j = 1 , … , {M}_{i} & ( 6 - 2 )\end{matrix}$$

with the same annotations as above and where d_{B}_{ᵢ} is the distance separating the point Bᵢ and the orthogonal projection of R on the second radiating cable;

$${η}_{B} = \frac{c}{{v}_{B}}$$

is the velocity factor of the second radiating cable, and

$${w}_{{B}_{i}}^{j}$$

is a measurement noise.

If the measurement noises

$${w}_{{B}_{i}}^{j} and {w}_{{B}_{i}}^{j}$$

are disregarded, and similarly to equation (2), the deviations between the pseudo-distances measured by the GNSS receiver and the reference pseudo-distances are given by:

$$\begin{matrix}[ Math . 10 ] & \\ Δ {ρ}_{{A}_{i}}^{j} = {\tilde{ρ}}_{{A}_{i}}^{j} - {ρ}_{{A}_{i}}^{j} = {η}_{A} {d}_{{A}_{i}} + y + b , j = 1 , … , {N}_{i} & ( 7 - 1 )\end{matrix}$$

$$\begin{matrix}[ Math . 11 ] & \\ Δ {ρ}_{{B}_{i}}^{j} = {\tilde{ρ}}_{{B}_{i}}^{j} - {ρ}_{{B}_{i}}^{j} = {η}_{B} {d}_{{B}_{i}} + ( H - y ) + b , j = 1 , … , {M}_{i} & ( 7 - 2 )\end{matrix}$$

As in the first aspect, the measured pseudo-distances,

$${\tilde{ρ}}_{{A}_{i}}^{j} and {\tilde{ρ}}_{{B}_{i}}^{j}$$

are provided directly by the GNSS receiver, and the reference pseudo-distances,

$${ρ}_{{A}_{i}}^{j} and {ρ}_{{B}_{i}}^{j}$$

are known to the mobile terminal, the different variants described in the first aspect also being applicable to the second aspect.

Regardless of the alternative aspect, the local coordinates (x_{A}_{ᵢ}, y_{A}_{ᵢ}, z_{A}_{ᵢ}) of the ends Aᵢ, i=1.2 of the first radiating cable as well as those (x_{B}_{ᵢ}, y_{B}_{ᵢ}, z_{B}_{ᵢ}) of the ends Bᵢ, i=1.2 of the second radiating cable are known to the mobile terminal.

The mobile terminal solves a system of N₁+N₂+M₁+M₂ navigation equations where the distances d_{A} d_{A}_{₁} (or L_{A}−d_{A}=d_{A}_{₂}), d_{B}=d_{B}_{₁} (or L_{B}−d_{B}=d_{B}_{₂}), y, and clock offset b are unknowns:

$$\begin{matrix}[ Math . 12 ] & \\ Δ {ρ}_{{A}_{1}}^{j} = {\tilde{ρ}}_{{A}_{1}}^{j} - {ρ}_{{A}_{1}}^{j} = {η}_{A} {d}_{A} + y + b , j = 1 , … , {N}_{1} & ( 8 - 1 )\end{matrix}$$

$$\begin{matrix}[ Math . 13 ] & \\ Δ {ρ}_{{A}_{2}}^{j} = {\tilde{ρ}}_{{A}_{2}}^{j} - {ρ}_{{A}_{2}}^{j} = {η}_{A} ( {L}_{A} - {d}_{A} ) + y + b , j = 1 , … , {N}_{2} & ( 8 - 2 )\end{matrix}$$

$$\begin{matrix}[ Math . 14 ] & \\ {Δρ}_{{B}_{1}}^{j} = {\tilde{ρ}}_{{B}_{1}}^{j} - {ρ}_{{B}_{1}}^{j} = {η}_{B} {d}_{B} + ( H - y ) + b , j = 1 , … , {M}_{1} & ( 8 - 3 )\end{matrix}$$

$$\begin{matrix}[ Math . 15 ] & \\ {Δρ}_{{B}_{2}}^{j} = {\tilde{ρ}}_{{B}_{2}}^{j} - {ρ}_{{B}_{2}}^{j} = {η}_{B} ( {L}_{B} - {d}_{B} ) + ( H - y ) + b , j = {1}_{,} … , {M}_{2} & ( 8 - 4 )\end{matrix}$$

The system of navigation equations (8-1) to (8-4) is a system of at least 4 equations with 4 unknowns, d_{A}, d_{B}, y, b. It can be solved conventionally as in the first aspect.

For example, the pseudo-distance deviations,

$$Δ {ρ}_{{A}_{1}}^{j} and {Δρ}_{{A}_{2}}^{j}$$

can be averaged on the subsets Ω_{A}_{₁} and Ω_{A}_{₂}, respectively associated with the ends A₁ and A₂ of the first cable, according to (4-1) and (4-2). Similarly, the pseudo-distance deviations

$$Δ {ρ}_{{B}_{1}}^{j} and {Δρ}_{{B}_{2}}^{j}$$

can be averaged on the subsets Ω_{B}_{₁} and Ω_{B}_{₂}, respectively associated with the ends B₁ and B₂ of the second cable:

$$\begin{matrix}[ Math . 16 ] & \\ Δ {ρ}_{{B}_{1}} = \frac{1}{{M}_{1}} {\sum }_{j = 1}^{{M}_{1}} Δ {ρ}_{{B}_{1}}^{j} & ( 9 - 1 )\end{matrix}$$

$$\begin{matrix}[ Math . 17 ] & \\ Δ {ρ}_{{B}_{2}} = \frac{1}{{M}_{2}} {\sum }_{j = 1}^{{M}_{2}} Δ {ρ}_{{B}_{2}}^{j} & ( 9 - 2 )\end{matrix}$$

Similarly to equation (5), the x-axes are then deduced therefrom on the axes of the two radiating cables:

$$\begin{matrix}[ Math . 18 ] & \\ {d}_{A} = \frac{( Δ {ρ}_{{A}_{1}} - Δ {ρ}_{{A}_{2}} ) / {η}_{A} + {L}_{A}}{2} & ( 10 - 1 )\end{matrix}$$

$$\begin{matrix}[ Math . 19 ] & \\ {d}_{B} = \frac{( Δ {ρ}_{{B}_{1}} - Δ {ρ}_{{B}_{2}} ) / {η}_{B} + {L}_{B}}{2} & ( 10 - 2 )\end{matrix}$$

However, unlike the first aspect, the second aspect makes it possible to determine the ordinate y and clock offset b of the GNSS receiver with the synthetic GNSS signals, namely:

$$\begin{matrix}[ Math . 20 ] & \\ y = \frac{( Δ {ρ}_{{A}_{1}} - Δ {ρ}_{{B}_{1}} ) + ( Δ {ρ}_{{A}_{2}} - Δ {ρ}_{{B}_{2}} ) - ( {η}_{A} {L}_{A} - {η}_{B} {L}_{B} ) + 2 H}{4} & ( 10 - 3 )\end{matrix}$$

$$\begin{matrix}[ Math . 21 ] & \\ b = \frac{( Δ {ρ}_{{A}_{1}} + Δ {ρ}_{{B}_{1}} + Δ {ρ}_{{A}_{2}} + Δ {ρ}_{{B}_{2}} ) - ( {η}_{A} {L}_{A} + {η}_{B} {L}_{B} ) - 2 H}{4} & ( 10 - 4 )\end{matrix}$$

The disclosure of the second aspect has been made on the assumption that the two radiating cables were rectilinear, coplanar and parallel. However, a person skilled in the art will understand that these constraints can be relaxed and that it is sufficient in practice for the cables to be georeferenced, i.e. their curves to be known spatially. Indeed, in accordance with the first aspect, it is possible to determine the curvilinear coordinates of the orthogonal projections of the point, respectively on the first and second radiating cable. The distance H can then be estimated from:

$$\begin{matrix}[ Math . 22 ] & \\ H = \sqrt{{( {x}_{{d}_{A}} - {x}_{{d}_{B}} )}^{2} + {( {y}_{{d}_{A}} - {y}_{{d}_{B}} )}^{2} + {( {z}_{{d}_{A}} - {z}_{{d}_{B}} )}^{2}} & ( 11 )\end{matrix}$$

where (x_{d}_{_{A}}, y_{d}_{_{A}}, z_{d}_{_{A}}) and (x_{d}_{_{B}}, y_{d}_{_{B}}, z_{d}_{_{B}}) are the respective Cartesian coordinates of the orthogonal projections of the point R on the first and second radiating cables, deduced from estimating the distances d_{A} and d_{B}.

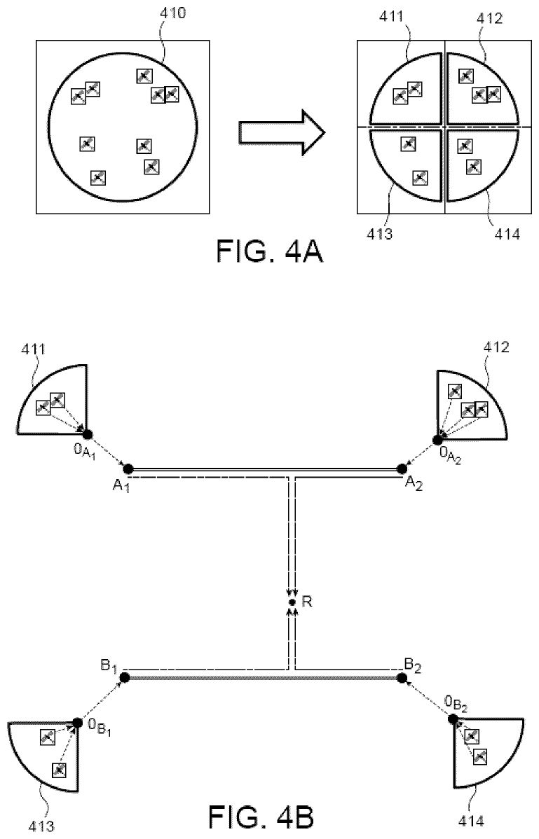

FIGS. 4A and 4B schematically illustrate an example of an open-sky partition that can be used in implementing a positioning method according to the second aspect of the disclosure.

A top view of an open-sky configuration showing a satellite constellation at a given time has been represented in 410. This configuration is partitioned here into four quadrants, 411, 412, 413, 414 corresponding for example respectively to the NW, NE, SW and SE directions.

FIG. 4B illustrates the first and second radiating cables in the indoor environment and the allocation of satellites/GNSS signals to the ends of each of these cables. It is verified that the subsets Ω_{A}_{ᵢ}, i=1.2 and Ω_{B}_{ᵢ}, i=1.2, are separate and that each of them comprises at least one element.

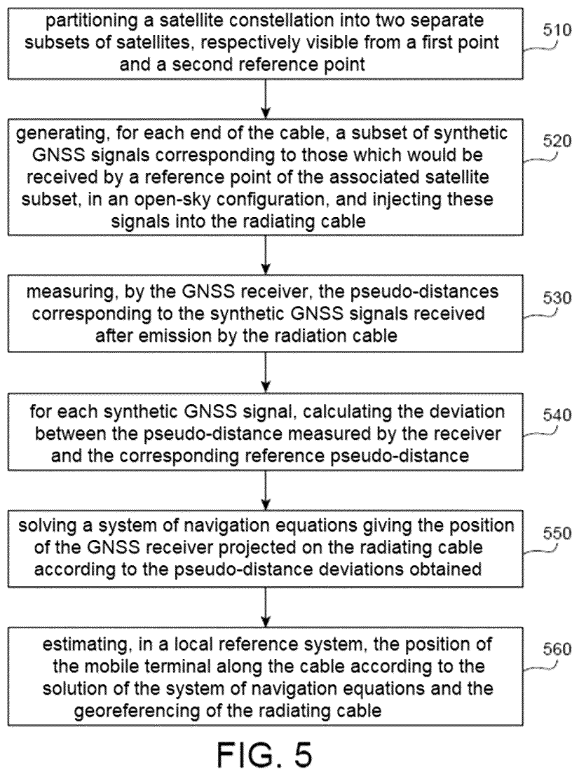

FIG. 5 schematically represents a positioning method according to the first aspect of the present disclosure.

This figure is placed in the context of a positioning system using a radiating cable as shown in FIG. 1.

In a first step, 510, a satellite constellation C is partitioned into two separate subsets, each subset C_{A}_{ᵢ} being associated in a biunivocal manner with one end of the cable, Aᵢ, the satellites of this subset all being visible from the reference point O_{A}_{ᵢ}, in an open-sky configuration.

In step 520, a subset of synthetic GNSS signals

$${Ω}_{{A}_{i}} = \{ {s}_{{A}_{i}}^{j} , j = 1 , … , {N}_{i} \} ,$$

is generated for each end Aᵢ, i=1.2, corresponding to the satellites of the subset C_{A}_{ᵢ} which would be received at the reference point O_{A}_{ᵢ} at the time t, in an open-sky configuration. The generated synthetic GNSS signals are injected at each end of the associated radiating cable Aᵢ.

In step 530, the GNSS receiver of the mobile terminal measures the pseudo-distances,

$${\tilde{ρ}}_{{A}_{i}}^{j} ,$$

corresponding to the synthetic GNSS signals received, after propagation in the radiating cable, i.e.

$${s}_{{A}_{i}}^{j} ,$$

j=1, . . . , Nᵢ, i=1.2.

In step 540, the mobile terminal calculates the deviations

$$Δ {ρ}_{{A}_{i}}^{j}$$

between the pseudo-distances

$${\tilde{ρ}}_{{A}_{i}}^{j}$$

measured by the GNSS receiver in the previous step and the corresponding reference pseudo-distances,

$${ρ}_{{A}_{i}}^{j} ,$$

obtained by calculation.

In step 550, the terminal solves a system of navigation equations ((3-1), (3-2)) giving the position of the point R of the mobile terminal along the radiating cable, namely the distance d_{A}, as a function of the deviations

$$Δ {ρ}_{{A}_{1}}^{j} and {Δρ}_{{A}_{2}}^{j}$$

between measured pseudo-distances and reference pseudo-distances. The distance d_{A} is the distance separating the orthogonal projection of the point R on the cable and its end A₁. For example, the aforementioned system of navigation equations can be solved according to (5).

In step 560, the position of the mobile terminal is estimated from the solution of the system of navigation equations obtained in the previous step. For example, if the cable is rectilinear, it may be determined relatively to the coordinates of the ends of the radiating cable and the coordinate of the orthogonal projection of the position R on this cable. If the cable is curvilinear, it may be determined from the knowledge of the curve described by the cable spatially and the curvilinear coordinate of the projection of the position R on this cable.

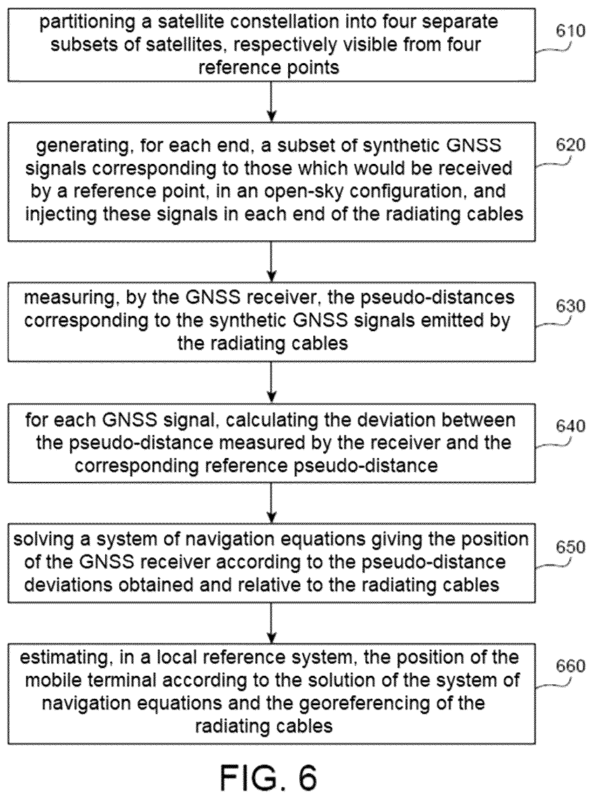

FIG. 6 schematically represents a positioning method according to a second aspect of the present disclosure.

This figure is placed in the context of a positioning system using a pair of radiating cables as shown in FIG. 3.

In step 610, a satellite constellation C is partitioned into four separate subsets, each subset C_{A}_{ᵢ} (or C_{B}_{ᵢ}) being associated in a biunivocal manner with one end of the first radiating cable, Aᵢ (or the second radiating cable Bᵢ). The satellites of the subset associated with one cable end are all visible from a simulated reference point O_{A}_{ᵢ} (or O_{B}_{ᵢ}), in an open-sky configuration.

In step 620, for each end Aᵢ of the first cable, (or Bᵢ of the second cable), a subset of synthetic GNSS signals,

$${Ω}_{{A}_{i}} = \{ {s}_{{A}_{i}}^{j} , j = 1 , … , {N}_{i} \} ( or$$

$${Ω}_{{B}_{i}} = \{ {s}_{{B}_{i}}^{j} , j = 1 , … , {M}_{i} \}$$

corresponding to the satellites of the subset C_{A}_{ᵢ} (or C_{B}_{ᵢ}) which would be received at the reference point O_{A}_{ᵢ} (or O_{B}_{ᵢ}) at the time t, in an open-sky configuration, is generated. The generated synthetic GNSS signals are injected at the associated ends Aᵢ (or Bᵢ) of the first (or second) radiating cable.

In step 630, the GNSS receiver of the mobile terminal measures the pseudo-distances,

$${\tilde{ρ}}_{{A}_{i}}^{j}$$

(or

$${\tilde{ρ}}_{{B}_{i}}^{j} )$$

corresponding to the synthetic GNSS signals received from the first (or second radiating cable), i.e.

$${s}_{{A}_{i}}^{j} ,$$

j=1, . . . , Nᵢ, i=1.2, (or

$${s}_{{B}_{i}}^{j} ,$$

j=1, . . . , Mᵢ, i=1.2).

In step 640, the mobile terminal calculates the deviations

$$Δ {ρ}_{{A}_{i}}^{j}$$

(or

$$Δ {ρ}_{{B}_{i}}^{j} )$$

between the pseudo-distances

$${\tilde{ρ}}_{{A}_{i}}^{j}$$

(or

$${\tilde{ρ}}_{{B}_{i}}^{j} )$$

measured by the GNSS receiver in the previous step and the corresponding reference pseudo-distances,

$${ρ}_{{A}_{i}}^{j}$$

(or

$${ρ}_{{B}_{i}}^{j} ) ,$$

obtained by calculation.

In step 650, the GNSS receiver of the terminal solves a system of navigation equations ((8-1) to (8-4)) giving, on one hand, the positions of the point R of the mobile terminal along the first and second radiating cables and, on the other, the distances of the point R to these cables, as a function of the deviations

$${Δρ}_{{A}_{1}}^{j} , Δ {ρ}_{{A}_{2}}^{j} , Δ {ρ}_{{B}_{1}}^{j} , Δ {ρ}_{{B}_{2}}^{j}$$

between the observed pseudo-distances and the reference pseudo-distances and the distance H separating the two cables. For example, the solution of the system of navigation equation may be based on the relations (10-1) to (10-4).

Finally, in step 660, the position of the mobile terminal is estimated from the solution of the system of navigation equations obtained in the previous step. For example, it may be determined relatively with respect to a first origin taken at one end of the first cable (or the second cable).

As mentioned above, the second aspect extends to the scenario of curvilinear radiating cables, the coordinates of d_{A}_{₁}, d_{B}_{₁} of the projection of the position of the mobile terminal on the axes of the cables being replaced by the curvilinear coordinates along these cables.

A person skilled in the art will understand that the disclosure also extends to the scenario of at least three non-coplanar radiating cables, making it possible to estimate the three-dimensional position of the receiver in question.

What is claimed is:

1. A method for positioning a mobile terminal in an indoor environment wherein at least one first radiating cable having a first end and a second end is located, wherein:
at least a part of a satellite constellation is partitioned into a first and a second separate subsets of satellites, which would be respectively visible from a first reference point and a second reference point, in an open-sky configuration;
for the first, or the second, end, a first, or a second, subset of synthetic GNSS signals corresponding to those which would be received, in an open-sky configuration, is generated by the first, or the second, reference point, from satellites belonging to the first, or the second, subset, the first, or the second, end injecting the first, or the second, subset of synthetic GNSS signals thus generated into the radiating cable;
the GNSS receiver of the mobile terminal measures the pseudo-distances corresponding to the synthetic GNSS signals received from the radiating cable;
for each synthetic GNSS signal of the first, or the second subset, a deviation between the pseudo-distance measured by the GNSS receiver and a reference pseudo-distance calculated for the first, or the second, reference point is determined;
the position of the mobile terminal along the cable is estimated from the pseudo-distance deviations thus obtained and a georeferenced curve describing the radiating cable.

2. The method for positioning a mobile terminal according to claim 1, wherein the position of the mobile terminal along the radiating cable is obtained by solving a system of equations giving the deviations of the pseudo-distances as a function of said position.

3. The method for positioning a mobile terminal according to claim 2, wherein the system of equations is given by:
$${η}_{A} {d}_{A} + y + b = Δ {ρ}_{{A}_{1}}^{j} , j = 1 , … , {N}_{1}$$
$${η}_{A} ( {L}_{A} - {d}_{A} ) + y + b = Δ {ρ}_{{A}_{2}}^{j} , j = 1 , … , {N}_{2}$$
where η_{A} is the ratio between the speed of light and the propagation speed of an electromagnetic wave in the radiating cable, d_{A} is the position of the mobile terminal along the radiating cable taking the first end as the origin, L_{A} is the length of the radiating cable, y is the distance to the radiating cable, b is the clock offset of the GNSS receiver relative to the clock used to generate the synthetic GNSS signals,
$$Δ {ρ}_{{A}_{1}}^{j} ,$$
j=1, . . . , N₁ are the deviations between the pseudo-distances measured by the GNSS receiver and the corresponding reference pseudo-distances, obtained for the N₁ synthetic GNSS signals of the first subset,
$$Δ {ρ}_{{A}_{2}}^{j} ,$$
j=1, . . . , N₂, are the deviations between the pseudo-distances measured by the GNSS receiver and the corresponding reference pseudo-distances, obtained for the N₂ synthetic GNSS signals of the second subset.

4. The method for positioning a mobile terminal according to claim 3, wherein the position of the mobile terminal along the radiating cable is given by:
$${d}_{A} = \frac{( Δ {ρ}_{{A}_{1}} - Δ {ρ}_{{A}_{2}} ) / {η}_{A} + {L}_{A}}{2}$$
where
$$Δ {ρ}_{{A}_{1}} = \frac{1}{{N}_{1}} {\sum }_{j = 1}^{{N}_{1}} Δ {ρ}_{{A}_{1}}^{j} , Δ {ρ}_{{A}_{2}} = \frac{1}{{N}_{2}} {\sum }_{j = 1}^{{N}_{2}} Δ {ρ}_{{A}_{2}}^{j}$$
are respectively the mean of the pseudo-distance deviations on the first and second subsets.

5. A method for positioning a mobile terminal in an indoor environment wherein at least a first radiating cable and a second radiating cable are located, each radiating cable having a first end and a second end, wherein:
at least a part of a satellite constellation is partitioned into a first, second, third and fourth separate subsets of satellites, which would be respectively visible from a first, second, third and fourth point of reference in an open-sky configuration;
for the first, or the second, end of the first cable, a first, or a second, subset of synthetic GNSS signals corresponding to those which would be received, in an open-sky configuration, is generated by the first, or the second, reference point, from satellites belonging to the first, or the second, subset, the first, or the second, end of the first cable injecting the first, or the second, subset of synthetic GNSS signals thus generated into the first radiating cable;
for the first, or the second, end of the second cable, a third, or a fourth subset of synthetic GNSS signals corresponding to those which would be received, in an open-sky configuration, is generated by the third, the fourth, reference point, from satellites belonging to the third, or the fourth, subset, the first, or the second, end of the second cable injecting the third, or the fourth, subset of synthetic GNSS signals thus generated into the second radiating cable;
the GNSS receiver of the mobile terminal measures the pseudo-distances corresponding to the synthetic GNSS signals received from the first and second radiating cables;
for each synthetic GNSS signal of the first, or the second, third, fourth, subset, a deviation between the pseudo-distance measured by the GNSS receiver and a reference pseudo-distance calculated for the first, or the second, third, fourth, reference point is determined;
the position of the mobile terminal along the first and/or second cable and the distance to the first and/or second cable are estimated using the deviations of the pseudo-distances thus obtained and georeferenced curves respectively describing the first and second radiating cables.

6. The method for positioning a mobile terminal according to claim 5, wherein the position of the mobile terminal along the first and/or second radiating cable and the distance to the first and/or second cable is obtained by solving a system of equations giving the deviations of the pseudo-distances as a function of the position of the mobile terminal, respectively along the first radiating cable and the second radiating cable, as well as its distance respectively to the first radiating cable and the second radiating cable.

7. The method for positioning a mobile terminal according to claim 6, wherein the first and second radiating cables are parallel and separated by a distance H and that the system of equations is given by:
$${η}_{A} {d}_{A} + y + b = Δ {ρ}_{{A}_{1}}^{j} , j = 1 , … , {N}_{1} ;$$
$${η}_{A} ( {L}_{A} - {d}_{A} ) + y + b = Δ {ρ}_{{A}_{1}}^{j} , j = 1 , … , {N}_{2} ;$$
$${η}_{B} {d}_{B} + ( H - y ) + b = Δ {ρ}_{{B}_{1}}^{j} , j = 1 , … , {M}_{1} ;$$
$${η}_{B} ( {L}_{B} - {d}_{B} ) + ( H - y ) + b = Δ {ρ}_{{B}_{2}}^{j} , j = 1 , … , {M}_{2} ;$$
where η_{A}, η_{B} is the ratio between the speed of light and the propagation speed of an electromagnetic wave respectively in the first and second radiating cable; d_{A}, d_{B} is the position of the mobile terminal respectively along the first and second radiating cable taking the first end of these cables as the origin; L_{A}, L_{B} is the respective length of the first and second radiating cable, y is the distance from the user to the first radiating cable, b is the clock offset of the GNSS receiver relative to the clock used to generate the synthetic GNSS signals;
$$Δ {ρ}_{{A}_{1}}^{j} ,$$
j=1, . . . , N₁ and
$${Δρ}_{{A}_{2}}^{j} ,$$
j=1, . . . , N₂ are the deviations between the pseudo-distances measured by the GNSS receiver and the corresponding reference pseudo-distances, respectively obtained for the N₁ synthetic GNSS signals of the first subset and the N₂ synthetic GNSS signals of the second subset;
$$Δ {ρ}_{{B}_{1}}^{j} ,$$
j=1, . . . , M₁ and
$$Δ {ρ}_{{B}_{2}}^{j} ,$$
j=1, . . . , M₂ are the deviations between the pseudo-distances measured by the GNSS receiver and the corresponding reference pseudo-distances, respectively obtained for the M₁ synthetic GNSS signals of the third subset, and the M₂ synthetic GNSS signals of the fourth subset.

8. The method for positioning a mobile terminal according to claim 7, wherein the position of the mobile terminal along the first, or the second radiating cable is given by:
$${d}_{A} = \frac{( Δ {ρ}_{{A}_{1}} - Δ {ρ}_{{A}_{2}} ) / {η}_{A} + {L}_{A}}{2}$$
$${d}_{B} = \frac{( {Δρ}_{{B}_{1}} - Δ {ρ}_{{B}_{2}} ) / {η}_{B} + {L}_{B}}{2}$$
where
$$Δ {ρ}_{{A}_{1}} = \frac{1}{{N}_{1}} {\sum }_{j = 1}^{{N}_{1}} Δ {ρ}_{{A}_{1}}^{j} , Δ {ρ}_{{A}_{2}} = \frac{1}{{N}_{2}} {\sum }_{j = 1}^{{N}_{2}} Δ {ρ}_{{A}_{2}}^{j}$$
are respectively the mean of the pseudo-distance deviations on the first and second subsets, and,
$${Δρ}_{{B}_{1}} = \frac{1}{{M}_{1}} {\sum }_{j = 1}^{{M}_{1}} Δ {ρ}_{{B}_{1}}^{j} , Δ {ρ}_{{B}_{2}} = \frac{1}{{M}_{2}} {\sum }_{j = 1}^{{M}_{2}} Δ {ρ}_{{B}_{2}}^{j}$$
are respectively the mean of the pseudo-distance deviations on the third and fourth subsets.

9. The method for positioning a mobile terminal according to claim 8, wherein the distance of the mobile terminal to the first radiating cable is given by:
$$y = \frac{( Δ {ρ}_{{A}_{1}} - Δ {ρ}_{{B}_{1}} ) + ( Δ {ρ}_{{A}_{2}} - Δ {ρ}_{{B}_{2}} ) - ( {η}_{A} {L}_{A} - {η}_{B} {L}_{B} ) + 2 H}{4}$$

10. The method for positioning a mobile terminal according to claim 1, wherein the synthetic GNSS signals are generated by means of a simulator receiving at least one actual satellite signal from a satellite of the constellation, via an antenna located in an outdoor environment, the synthetic GNSS signals being synchronized with respect to the actual satellite signal.

11. The method for positioning a mobile terminal according to claim 5, wherein the synthetic GNSS signals are generated by means of a simulator receiving at least one actual satellite signal from a satellite of the constellation, via an antenna located in an outdoor environment, the synthetic GNSS signals being synchronized with respect to the actual satellite signal.
